(19) United States
(12) Patent Application Publication
(10) Pub. No.: US 2011/0102966 A1
(43) Pub. Date: May 5, 2011

(54) MOLDED CAPACITOR AND METHOD FOR MANUFACTURING THE SAME

(76) Inventors: Hiroki Takeoka, Nara (JP); Hiroshi Kubota, Toyama (JP); Yukihiro Shimasaki, Hyogo (JP); Hiroshi Fujii, Toyama (JP); Yukikazu Ohchi, Osaka (JP)

(21) Appl. No.: 13/000,293

(22) PCT Filed: Jul. 1, 2009
(86) PCT No.: PCT/JP2009/003048

§ 371 Date: Dec. 20, 2010

(30) Foreign Application Priority Data
Jul. 10, 2008 (JP) 2008-179836
Jul. 10, 2008 (JP) 2008-179837
Jul. 10, 2008 (JP) 2008-179838

(51) Int. Cl. H01G 4/18; H01G 7/00

(52) U.S. Cl. 361/301.3; 29/25.41

(57) ABSTRACT

A molded capacitor includes a capacitor-element assembly, a package covering the capacitor-element assembly, and a supporter embedded in the package. The capacitor-element assembly includes a capacitor element having a first electrode, and a busbar joined to the electrode of the capacitor element. The busbar has a terminal. The package is made of norbornene-based resin and covers the capacitor-element assembly while exposing the terminal of the busbar. The supporter has first and second end section and is made of heat-conductive insulating material. The first end section contacts the capacitor-element assembly. The second end section is exposed from the package. This molded capacitor has high heat resistance and a small, light-weighted body, and can be manufactured inexpensively.

### TECHNICAL FIELD

The present invention relates to a molded capacitor that includes a capacitor element and a package covering the capacitor element, and that is used in various electronic devices, electric devices, industrial devices, and automobiles for working with a high electric current. The present invention also relates to a method for manufacturing the molded capacitor.

### BACKGROUND ART

In recent years, almost every electric device is controlled by an inverter circuit so that energy can be saved and the higher efficiency can be achieved, whereby the environment can be protected. Particularly in an automobile industry, techniques for promoting environmental protection, energy saving, and higher efficiency have been actively developed. Those efforts result in, for instance, an introduction of a hybrid electric vehicle (HEV) to the market, where the HEV can be driven by an electric motor and an engine.

The electric motor employed in the HEV works in a high voltage range, such as several hundreds volts. A metallized-film capacitor featuring a high withstand voltage and a low energy loss has drawn attention as a capacitor to be used in such an electric motor. This metallized-film capacitor can meet the demand from the market for maintenance-free products because of its long service life. The metallized-film capacitor thus has been increasingly employed in the HEV.

The HEV strongly requires a metallized-film capacitor capable of withstanding a higher voltage, working with a large current, and having a large capacitance. To meet these requirements, a molded capacitor has been developed and is put in the market. In this molded capacitor, plural metallized-film capacitors are coupled together in parallel with a busbar, and are accommodated in a case filled with molding resin.

FIG. 27 is a sectional view of conventional molded capacitor 501 disclosed in Patent Literatures 1 and 2. Capacitor element 111 includes two metallized films each including a dielectric film and a deposited metal electrode formed on a surface of the dielectric film. Capacitor element 111 is formed by rolling the metallized film together. A pair of electrodes 111A are formed on both of end surfaces of the rolled films.

Respective one ends of busbars 112 are connected to electrodes 111A. Respective other ends of busbars 112 functions as external connection terminals 112A. Case 113 opening upward and made of resin accommodates capacitor element 111 having busbars 112 connected thereto. Molding resin 114 fills a space between capacitor element 111 and an inner wall of case 113 so that external connection terminals 112A are exposed from case 113, thus providing molded capacitor 501.

Molding resin 114 covers capacitor elements 111 in order to improve the moisture resistance of element 111. This structure not only prevents the ambient moisture from entering but also builds a tough capacitor 501 by taking advantage of hardness as well as high shock resistance of the resin.

Conventional molded capacitor 501 is used for smoothing an alternating-current component of a direct-current power source to meet the requirements of the HEV for a smaller and lighter body as well as for a large capacitance. A large ripple current flows to capacitor 501, so that capacitor element 111 generates a large amount of heat.

Molding resin 114 is often made of epoxy resin, which needs a certain thickness to obtain sufficient moisture resistance. Since the epoxy resin requires a certain time to be hardened, it takes a long time to obtain an enough thickness of molding resin 114 in case 113 made of resin for securing the moisture resistance. The productivity of capacitor 501 is thus obliged to lower, and on top of that, capacitor 501 requires case 113 made of resin, so that the number of components increases, which raises a cost and increases the size of an apparatus including capacitor 501. Capacitor 501 with case 113 made of resin accommodated in a metal case increases the size of the apparatus.

### Citation List

### Patent Literature

Patent Literature 1: Japanese Patent Laid-Open Publication No. 2000-58380

Patent Literature 2: Japanese Patent Laid-Open Publication No. 2000-323352

### SUMMARY OF INVENTION

A molded capacitor includes a capacitor-element assembly, a package covering the capacitor-element assembly, and a supporter embedded in the package. The capacitor-element assembly includes a capacitor element having a first electrode, and a busbar joined to the electrode of the capacitor element. The busbar has a terminal. The package is made of norbornene-based resin and covers the capacitor-element assembly while exposing the terminal of the busbar. The supporter has first and second end section and is made of heat-conductive insulating material. The first end section contacts the capacitor-element assembly. The second end section is exposed from the package.

This molded capacitor has high heat resistance and a small, light-weighted body, and can be manufactured inexpensively.

### BRIEF DESCRIPTION OF DRAWINGS

FIG. 1A is a perspective view of a molded capacitor in accordance with Exemplary Embodiment 1 of the present invention.

FIG. 1B is an exploded perspective view of a capacitor element of the molded capacitor in accordance with Embodiment 1.

FIG. 2 is a front sectional view of the molded capacitor in accordance with Embodiment 1.

FIG. 3 is a side sectional view of the molded capacitor in accordance with Embodiment 1.

FIG. 4A is a sectional view of a supporter of the molded capacitor in accordance with Embodiment 1.

FIG. 4B is a sectional view of another supporter of the molded capacitor in accordance with Embodiment 1.

FIG. 4C is a sectional view of still another supporter of the molded capacitor in accordance with Embodiment 1.

FIG. 4D shows a sectional view of a further supporter of the molded capacitor in accordance with Embodiment 1.

FIG. 5 is a perspective view of a molded capacitor in accordance with Exemplary Embodiment 2 of the invention.

FIG. 6 is a front sectional view of the molded capacitor in accordance with Embodiment 2.

FIG. 7 is a side sectional view of the molded capacitor in accordance with Embodiment 2.

FIG. 8A is a perspective view of a molded capacitor in accordance with Exemplary Embodiment 3 of the invention.

FIG. 8B is a perspective view of the molded capacitor in accordance with Embodiment 3.

FIG. 9 is a perspective view of the molded capacitor in accordance with Embodiment 3 for illustrating a method of manufacturing the capacitor

FIG. 10A is a perspective view of the molded capacitor in accordance with Embodiment 3 for illustrating another method of manufacturing the capacitor.

FIG. 10B is a perspective view of the molded capacitor shown in FIG. 10A for illustrating the method of manufacturing the capacitor.

FIG. 11 shows dimensional accuracies of molded capacitors in accordance with Embodiment 3.

FIG. 12 is a perspective view of a molded capacitor in accordance with Exemplary Embodiment 4 of the invention.

FIG. 13 is a front sectional view of the molded capacitor in accordance with Embodiment 4.

FIG. 14 is a side sectional view of the molded capacitor in accordance with Embodiment 4.

FIG. 15 is a perspective view of a molded capacitor in accordance with Exemplary Embodiment 5 of the invention.

FIG. 16 is a front sectional view of the molded capacitor in accordance with Embodiment 5.

FIG. 17 is a side sectional view of the molded capacitor in accordance with Embodiment 5.

FIG. 18 is a perspective view of a package of the molded capacitor in accordance with Embodiment 5.

FIG. 19 is a front sectional view of the package of the molded capacitor in accordance with Embodiment 5.

FIG. 20 is a side sectional view of the package of the molded capacitor in accordance with Embodiment 5.

FIG. 21 is a bottom perspective view of the molded capacitor in accordance with Embodiment 5.

FIG. 22 shows a temperature of the molded capacitor in accordance with Embodiment 5.

FIG. 23 is a perspective view of a molded capacitor in accordance with Exemplary Embodiment 6 of the invention.

FIG. 24 is a front sectional view of a molded capacitor in accordance with Exemplary Embodiment 7 of the invention.

FIG. 25 is a front sectional view of a molded capacitor in accordance with Embodiment 7.

FIG. 26 is a front sectional view of another molded capacitor in accordance with Embodiment 7.

FIG. 27 is a sectional view of a conventional molded capacitor.

### DETAIL DESCRIPTION OF PREFERRED EMBODIMENTS

### Exemplary Embodiment 1

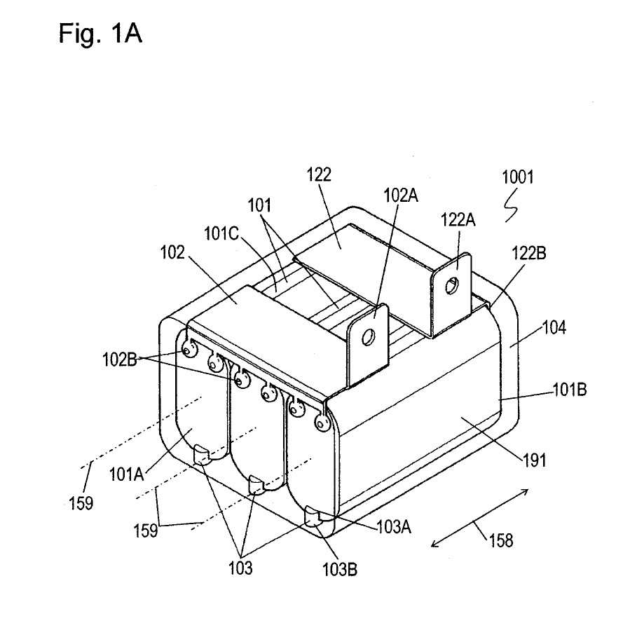

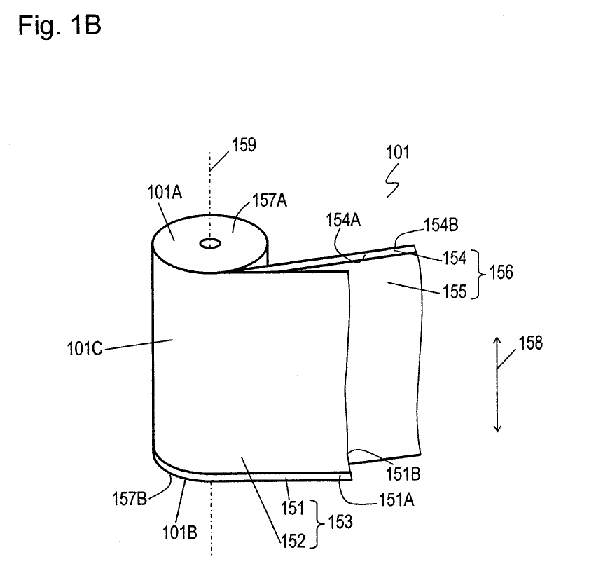

FIG. 1A is a perspective view of molded capacitor 1001 in accordance with Exemplary Embodiment 1 of the present invention. FIG. 1B is an exploded perspective view of capacitor element 101 of molded capacitor 1001. Capacitor 1001 includes three capacitor elements 101 connected in parallel to each other. Each capacitor element 101 includes two metallized films 153 and 156 and electrodes 101A and 101B. Metallized film 153 includes dielectric film 151 made of e.g. polypropylene and electrode film 152 formed on surface 151A of dielectric film 151. Metallized film 156 includes dielectric film 154 made of e.g. polypropylene and electrode film 155 formed on surface 154A of dielectric film 154. Electrode films 152 and 155 are formed by depositing metal, such as aluminum, on surfaces 151A and 154A of dielectric films 151 and 154, respectively. Dielectric films 151 and 154 have surfaces 151B and 154B opposite to surfaces 151A and 154A, respectively. Metallized films 153 and 156 are stacked together and rolled about center axis 159, such that electrode film 155 contacts the surface 151B of dielectric film 151. This rolling allows electrode film 152 to contact the surface 154B of dielectric film 154. Each capacitor element 101 extends in longitudinal direction 158 parallel with center axis 159. Electrode films 152 and 155 are placed on surfaces 151A and 151B of dielectric film 151 opposite to each other, thus facing each other across dielectric film 151. Similarly, electrode films 152 and 155 are placed on surfaces 154A and 154B of dielectric film 154 opposite to each other, thus facing each other across dielectric film 154. Metallized films 153 and 156 rolled together have end surfaces 157A and 157B opposite to each other in center axis 159, and side surface 101C parallel with center axis 159. Electrodes 101A and 101B connected to electrode films 152 and 155 are provided on end surfaces 157A and 157B, respectively. Those electrodes are formed as sprayed metal electrodes formed by spraying metal, such as zinc, onto end surfaces 157A and 157B.

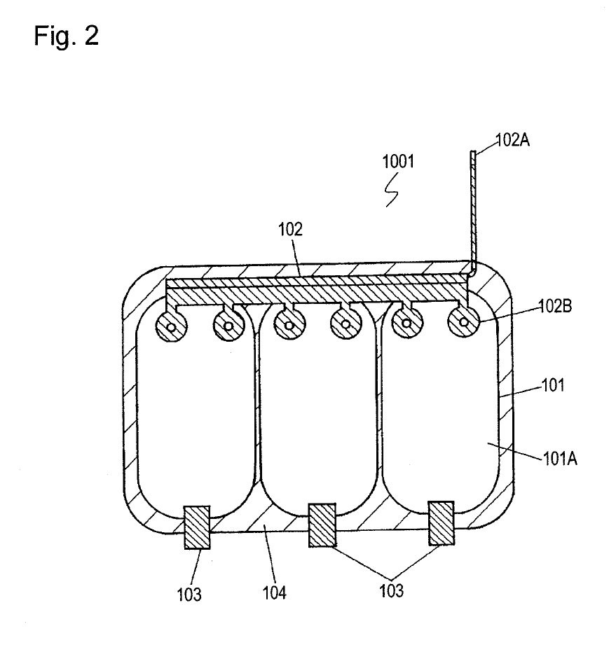

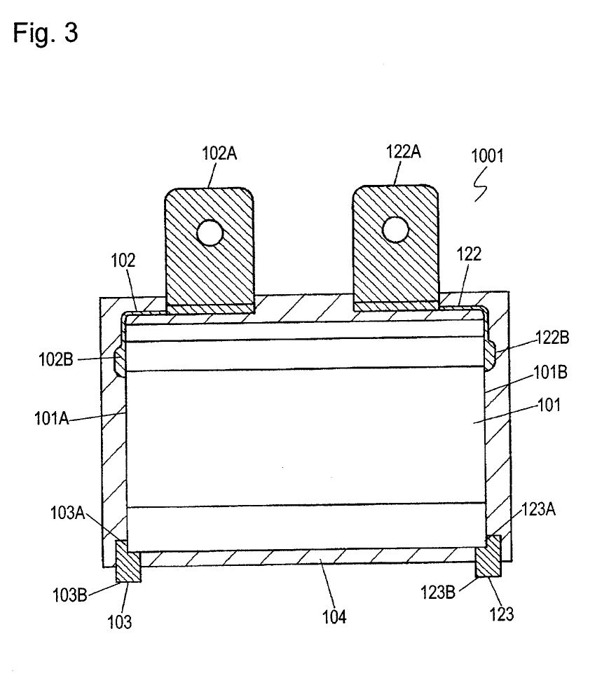

FIGS. 2 and 3 are a front sectional view and a side sectional view of capacitor 1001, respectively. Busbar 102 made of metal includes connecting sections 102B connected to electrode 101A by soldering and terminal 102A for external connection. Busbar 122 made of metal includes connecting sections 122B connected to electrodes 101B by soldering and terminal 122A for external connection. Busbars 102 and 122 extend along side surfaces 101C of plural capacitor elements 101 and perpendicularly to center axes 159 of capacitor elements 101. Plural capacitor elements 101 and busbars 102 and 122 joined to capacitor elements 101 form capacitor-element assembly 191.

Package 104 is made of norbornene-based resin, and covers capacitor elements 101, busbars 102 and 122 together such that terminals 102A and 122A of busbars 102 and 122 are exposed.

Supporter 103 embedded in package 104 includes end section 103A contacting electrode 101A of capacitor element 101 and end section 103B projecting and exposed from package 104. Supporter 123 embedded in package 104 includes end section 123A contacting electrode 101B of capacitor element 101 and end section 123B projecting and exposed from package 104. Supporters 103 and 123 are made of insulating material having higher heat conductivity than package 104.

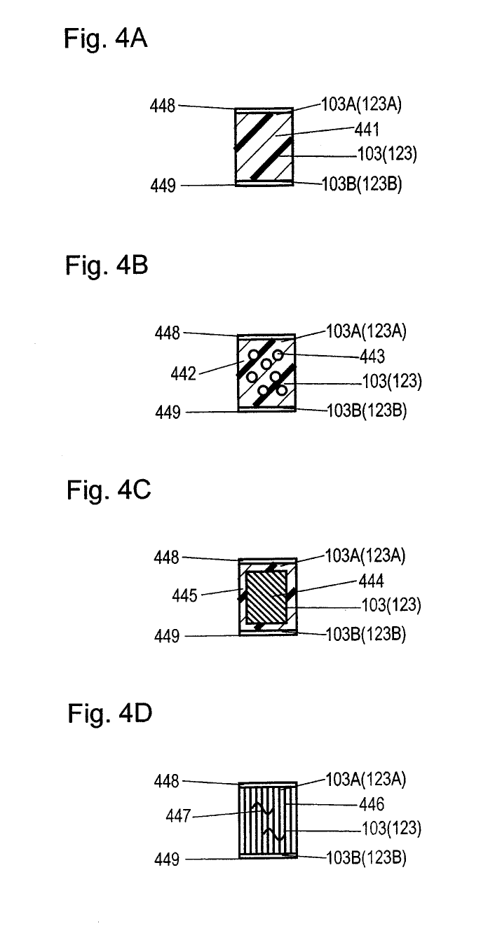

FIG. 4A is a sectional view of supporters 103 and 123. Supporters 103 and 123 are made of insulating material selected from the group consisting of silica, alumina, magnesium oxide, silicon nitride, boron nitride, and aluminum nitride.

FIG. 4B is a sectional view of other supporters 103 and 123. Each of supporters 103 and 123 may contain resin 442 and semiconductor 443, such as zinc oxide or silicon carbide, mixed with resin 442.

FIG. 4C is a sectional view of further supporters 103 and 123. Each of supporters 103 and 123 may include conductor 444, such as copper, aluminum, or iron, and insulator 445 covering conductor 444. Supporters 103 and 123 may be preferably made of alumina or magnesium oxide from a cost viewpoint. End sections 103A and 123A of supporters 103 and 123 are joined to capacitor-element assembly 191.

FIG. 4D is a sectional view of further supporters 103 and 123. Each of supporters 103 and 123 may include insulating fiber 446 and resin 447 covering and bundling fiber 446. Insulating fiber 446 can be made of, e.g. carbon fiber, glass fiber, ultrahigh molecular weight polyethylene fiber, or liquid crystalline resin fiber. Supporters 103 and 123 including insulating fiber 446 have high heat-conductivity along the direction in which fiber 446 extends, so that a high-heat conductivity cannot be obtained between each pit of fiber 446. In order for supporters 103 and 123 to allow the heat to transmit from end sections 103A and 123A contacting capacitor elements 101 to end sections 103B and 123B, insulating fiber 446 extends in a predetermined direction from end sections 103A and 123A to end sections 103B and 123B.

Supporters 103 and 123 are placed in a mold, and then, capacitor elements 101 having busbars 102 and 122 connected thereto are placed on supporters 103 and 123. Then, norbornene-based monomer is injected into the mold for forming package 104 by a reaction injection molding (RIM) method which reacts and hardens the monomer. Package 104 exposes terminals 102A and 122A from an upper surface of the package, and allows supporters 103 and 123 to project from a lower surface of the package to expose supporters 103 and 123 from the lower surface.

The norbornene-based monomer, a material of package 104, is two-part hardening type dicyclopentadiene (DCPD); however, it can be one-part hardening type DCPD that uses ruthenium catalyst.

In the mold, supporters 103 and 123 are more rigid and harder than the norbornene-based monomer, i.e. the material for package 104, and accordingly position capacitor elements 101 having busbars 102 and 122 connected thereto, thereby allowing package 104 to be molded dimensionally accurately.

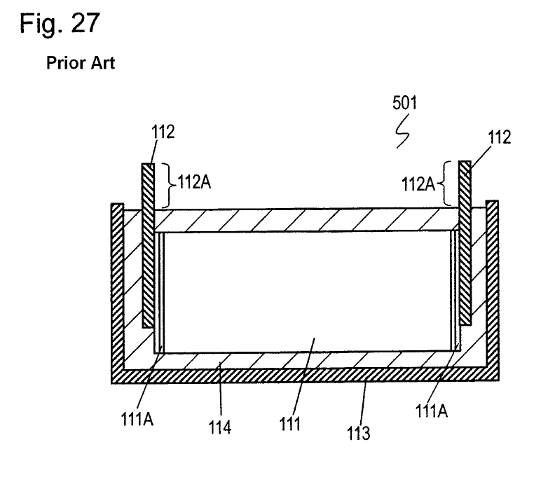

The norbornene-based monomer can be hardened within a short period of time, such as one minute, so that molded capacitor 1001 in accordance with Embodiment 1 can be manufactured without using resin case 113 used for conventional molded capacitor 501 shown in FIG. 27. Molded capacitor 1001 thus can be formed of a smaller number of components and downsized as well as light-weighted, and manufactured at a lower cost. Capacitor 1001 can improve its productivity substantially, so that it can be manufactured at a lower cost.

End sections 103A and 123A of supporters 103 and 123 made of insulating material having high heat-conductivity contact electrodes 101A and 101B of capacitor element 101, and have end sections 103B and 123B exposed from package 104. This structure allows the heat generated by capacitor element 101 to be dissipated to the outside of package 104 via supporters 103 and 123. This structure thus prevents capacitor element 101 from raising its temperature and improves the heat resistance of capacitor 1001. The temperature of capacitor element 101 of molded capacitor 1001 in accordance with Embodiment 1 can be lower by about 3 to 5° C. than that of capacitor element 101 of a comparative example of a molded capacitor which does not include supporter 103.

Heat-conductive grease 448 can be applied onto surfaces of end sections 103A and 123A of supporters 103 and 123 contacting electrodes 101A and 101B of capacitor element 101. This grease allows capacitor element 101 to dissipate heat efficiently via supporters 103 and 123. Heat-conductive grease 448 is general grease, such as silicone grease, fluorine-based grease, mixed with highly heat-conductive powder formed of, e.g. boron nitride, aluminum nitride, or zinc oxide.

Molded capacitor 1001 shown in FIGS. 1A and 3 includes three capacitor elements 101 with supporters 103 and 123 contacting all the three elements 101. The molded capacitor in accordance with Embodiment 1 includes three capacitor elements 101 coupled together with busbar 102, so that supporters 103 and 123 do not necessarily contact all three elements 101. In this case, the number of supporters 103 and 123 can be smaller than the number of capacitor elements 101. Even in this case, capacitor elements 101 can still produce the advantages discussed above, i.e. capacitor element 101 can dissipate heat sufficiently and can be positioned accurately.

End sections 103A and 123A of supporters 103 and 123 contact electrodes 101A and 101B of capacitor element 101, and end section 103B and 123B are exposed from package 104. According to Embodiment 1, end sections 103A and 123A of supporters 103 and 123 can be connected to busbars 102 and 122 which are made of highly heat-conductive metal. This structure allows the heat generated by capacitor element 101 to transmit to supporters 103 and 123 via busbars 102 and 122, thus allowing capacitor element 101 to dissipate heat efficiently. As discussed above, capacitor elements 101 coupled with busbars 102 and 122 are placed in the mold which is used for molding package 104, so that supporters 103 and 123 can position capacitor elements 101 although supporters 103 and 123 contact busbars 102 and 122.

According to Embodiment 1, supporters 103 and 123 are insert-molded in package 104; however, it is not limited to this method. Instead of supporters 103 and 123, pins can be placed in the mold together with capacitor-element assembly 191 for molding package 104. Then, the pins are removed out to produce cavities to accommodate supporters 103 and 123. Supporters 103 and 123 are then press-fitted into the cavities and embedded into package 104.

According to Embodiment 1, three capacitor elements 101 are coupled together in parallel; however, the number of capacitor elements 101 is not limited to three, or multiple capacitor elements 101 are not always needed. The number may be one.

According to Embodiment 1, molded capacitor 1001 employs wound-type metallized-film capacitor; however, capacitor 1001 is not limited to this type, and it can be another type, such as a multilayer metallized-film capacitor.

### Exemplary Embodiment 2

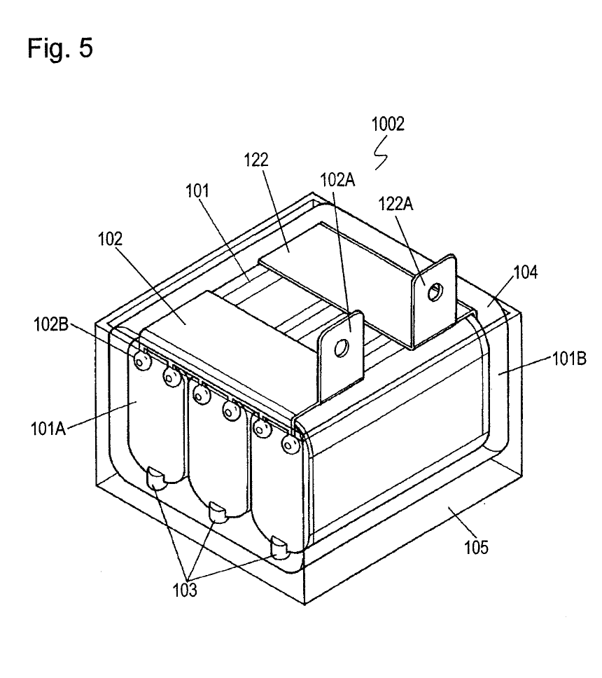

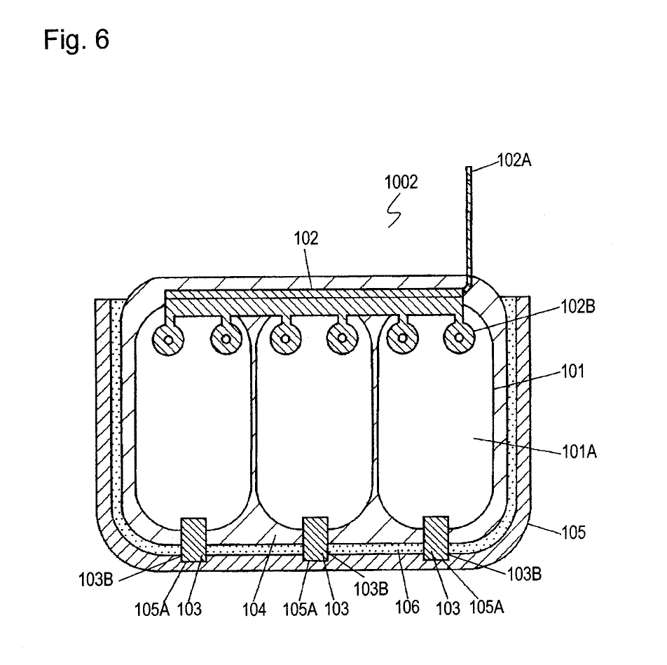

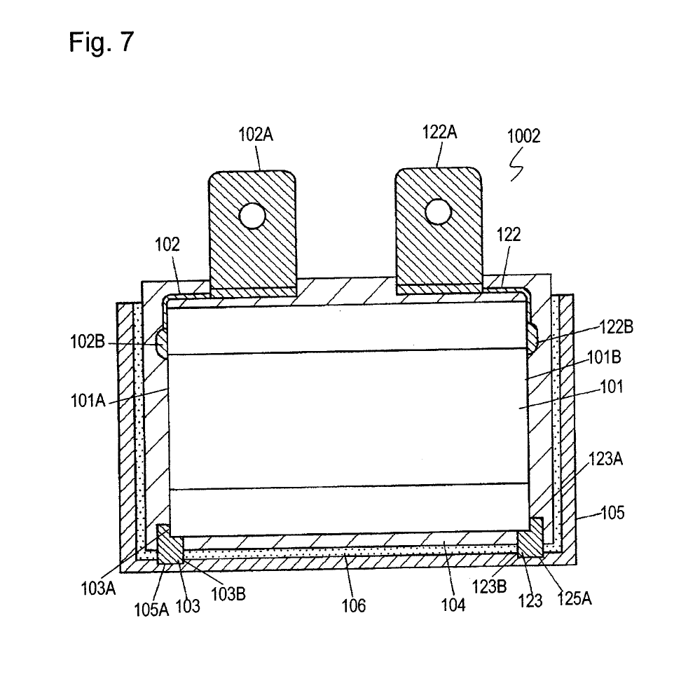

FIG. 5 is a perspective view of molded capacitor 1002 in accordance with Exemplary Embodiment 2 of the present invention. FIGS. 6 and 7 are a front sectional view and a side sectional view of molded capacitor 1002. In FIGS. 5 to 7, components identical to those of molded capacitor 1001 in accordance with Embodiment 1 shown in FIGS. 1A to 3 are denoted by the same reference numerals, and their description will be omitted. Molded capacitor 1002 includes case 105 and molding resin 106 in addition to components of molded capacitor 1001 shown in FIGS. 1A to 3.

Case 105 is made of material, such as metal, e.g. aluminum, having high heat conductivity, and accommodates capacitor elements 101 covered with package 104. Recesses 105A and 125A are provided in an inner surface of case 105. End sections 103B and 123B of supporters 103 and 123 projecting from the lower surface of package 104 are fitted into recesses 105A and 125A, thereby positioning package 104 with respect to case 105.

Insulating molding resin 106 fills between case 105 and package 104. Resin 106 is made of insulating resin, such as urethane resin or epoxy resin. The insulating resin can be mixed with heat-conductive filler or foaming agent.

In molded capacitor 1002 in accordance with Embodiment 2, supporters 103 and 123 projecting from package 104 are fitted into recesses 105A and 125A provided in the inner surface of case 105, thereby positioning package 104 with respect to case 105 accurately.

Molding resin 106 made of insulating resin, such as urethane resin or epoxy resin, mixed with heat-conductive filler fills case 105 which accommodates package 104, facilitating heat-dissipation from capacitor element 101. The insulating resin mixed with the foaming agent as the material for molding resin 106 increases the resistance against vibration.

Heat-conductive grease 449 (shown in FIGS. 4A to 4D) can be applied onto surfaces of end sections 103B and 123B of supporters 103 and 123 contacting recesses 105A and 125A of case 105. This grease allows capacitor element 101 to dissipate heat efficiently via supporters 103 and 123. Heat-conductive grease 449 is made of general grease, such as silicone grease, fluorine-based grease, mixed with highly heat-conductive powder made of, e.g. boron nitride, aluminum nitride, or zinc oxide.

In molded capacitor 1002 according to Embodiment 2, recesses 105A and 125A provided in the inner surface of case 105 accept end sections 103B and 123B of supporters 103 and 123 fitted thereto, respectively. However, case 105 may not necessarily have recesses 105A and 125A therein. For instance, as long as supporters 103 and 123 contact the inner surface of case 105, a similar advantage to what is discussed previously, i.e. heat dissipation effect, can be obtained.

### Exemplary Embodiment 3

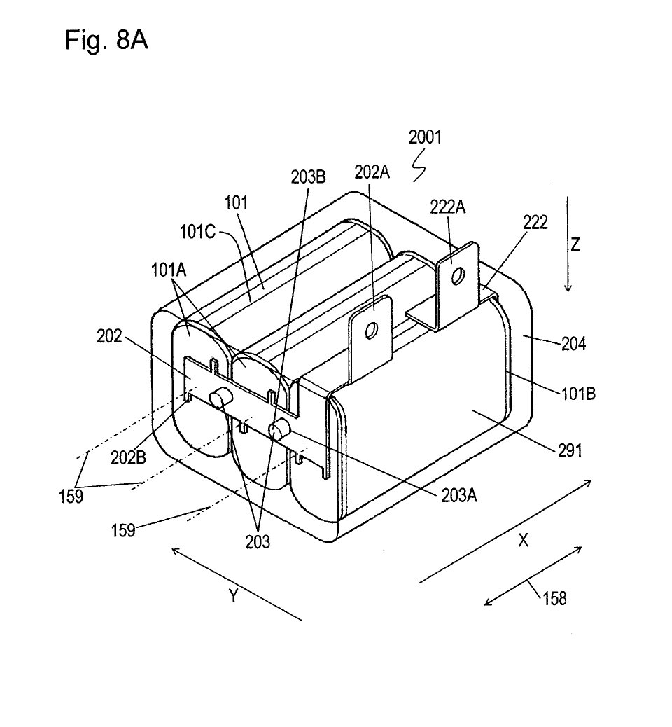

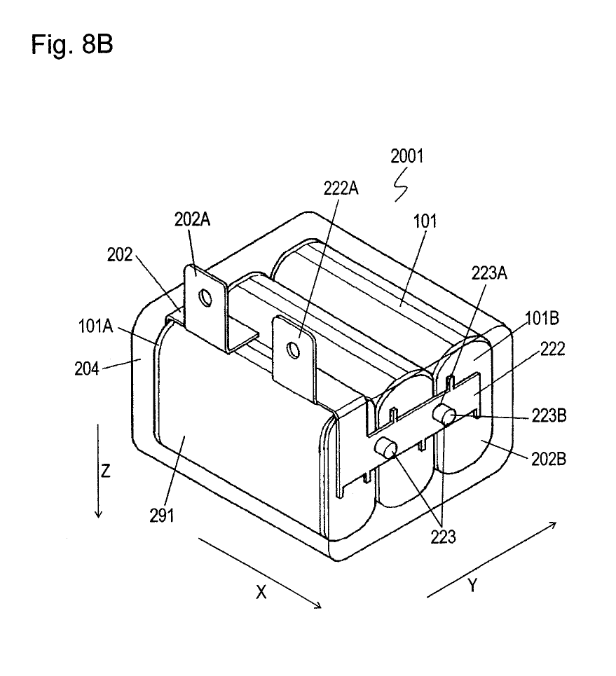

FIGS. 8A and 8B are perspective views of a molded capacitor in accordance with Exemplary Embodiment 3 of the present invention. In FIGS. 8A and 8B, component identical to those of molded capacitor 1001 in accordance with Embodiment 1 shown in FIGS. 1A to 3 are denoted by the same reference numerals, and their description will be omitted. FIGS. 8A and 8B are perspective views of capacitor 2001 viewed from electrodes 101A and 101B, respectively.

Busbar 202 made of metal includes connecting section 202B connected to electrode 101A of capacitor element 101 by soldering and terminal 202A for external connection. Busbar 222 made of metal includes connecting section 222B connected to electrode 101B of capacitor element 101 by soldering and terminal 222A for external connection. Busbar 202 extends across electrodes 101A of plural capacitor elements 101 perpendicularly to center axes 159 of elements 101. Busbar 222 extends across electrodes 101B of plural capacitor elements 101 perpendicularly to center axes 159 of elements 101. Capacitor elements 101 and busbars 202 and 222 joined to capacitor elements 101 together form capacitor-element assembly 291.

Package 204 is made of norbornene-based resin, and covers capacitor elements 101, busbars 202 and 222 together such that terminals 202A and 222A of busbars 202 and 222 are exposed.

Supporter 203 embedded in package 204 includes end section 203A contacting busbar 202 and end section 203B exposed from package 204. Supporter 223 embedded in package 204 includes end section 223A contacting busbar 222 and end section 223B exposed from package 204. Supporters 203 and 223 are made of insulating material having higher heat conductivity than package 204. Both of supporters 203 and 223, similar to supporters 103 and 123 shown in FIG. 4A, are made of insulating material selected from the group consisting of silica, alumina, magnesium oxide, silicon nitride, boron nitride, and aluminum nitride. Similar to supporters 103 and 123 shown in FIG. 4B, supporters 203 and 223 can be made of resin and semiconductor, e.g. zinc oxide or silicon carbide, mixed with the resin. Similar to supporters 103 and 123 shown in FIG. 4C, supporters 203 and 223 can be made of conductor, e.g. copper, aluminum, or iron, and insulator for covering the conductor. Supporters 203 and 223 are preferably made of alumina or magnesium oxide from a cost viewpoint. End sections 203A and 223A of supporters 203 and 223 are joined to capacitor-element assembly 291.

Similar to supporter 103 and 123 shown in FIG. 4D, supporters 203 and 223 can be made of insulating fiber and resin which covers and bundles the insulating fiber. The insulating fiber can be, e.g. carbon fiber, glass fiber, ultrahigh molecular weight polyethylene fiber, or liquid crystalline resin fiber. Supporters 203 and 223 made of the insulating fiber have high heat-conductivity along the extending direction of the fiber, so that high-heat conductivity cannot be obtained between each line of the fiber. Since supporters 203 and 223 allow the heat to transmit from end section 203A and 223A contacting busbars 202 and 222 to end section 203B and 223B, the insulating fiber extends from end sections 203A and 223A to end sections 203B and 223B of supporter 203 and 223.

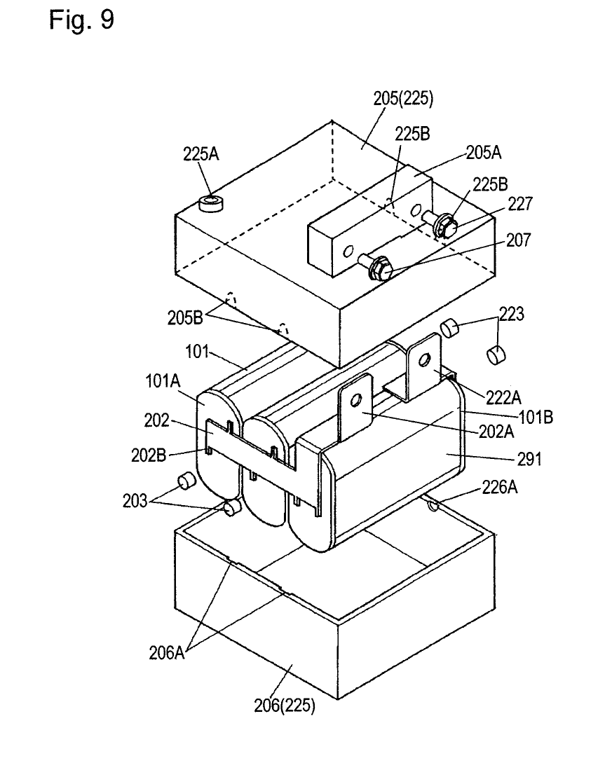

FIG. 9 is a perspective view of molded capacitor 2001 for illustrating a method of manufacturing capacitor 2001. Package 204 is molded with mold 225 including upper mold 205 and lower mold 206. Supporters 203 and 223 are placed to fit into supporter fixing sections 206A and 226A provided to an inner surface of lower mold 206. Capacitor elements 101 coupled with busbars 202 and 222 are placed in lower mold 206. Then, upper mold 205 is put over capacitor elements 101, and then, is fixed to lower mold 206. Busbar fixing section 205A is provided to upper mold 205. Terminals 202A and 222A of busbars 202 and 222 extend through upper mold 205 and are exposed to the outside of upper mold 205. Terminals 202A and 222A are fixed securely to busbar fixing section 205A with bolts 207 and 227 respectively. Supporter fixing sections 205B and 225B are provided at an inner surface of upper mold 205. Supporters 203 are nipped and fixed between supporter fixing sections 205B and 206A. Supporters 223 are nipped and fixed between supporter fixing sections 225B and 226A.

Then, norbornene-based monomer is injected from inlet 225A of mold 225 into mold 225, thereby forming molding package 204 by a Reaction Injection Molding (RIM) method. The norbornene-based monomer, the material for package 204, is two-part hardening type dicyclopentadiene (DCPD); however, it can be one-part hardening type DCPD that uses ruthenium catalyst.

End sections 203A and 223A of supporters 203 and 223 may preferably be fixed tentatively to busbars 202 and 222 with adhesive before package 204 is molded in order to improve workability and assure the contact between supporters 203 and 223 and busbars 202 and 222.

Supporter fixing sections 206A and 226A provided at lower mold 206 and supporter fixing sections 205B and 225B provided at upper mold 225 not only accurately position supporters 203 and 223 at predetermined places along a vertical direction but also absorb dimensional variations along longitudinal direction 158 of capacitor elements 101. Supporters 203 and 223 can be thus accurately and rigidly mounted to the predetermined places with respect to package 204.

End sections 203A and 223A of supporters 203 and 223 made of insulating material having high heat conductivity contact busbars 202 and 222 which contact electrodes 101A and 101B of capacitor element 101. End sections 203B and 223B are exposed from package 204. This structure allows the heat generated by capacitor element 101 to be dissipated to the outside of package 204 via supporters 203 and 223. The foregoing structure thus prevents capacitor element 101 from raising its temperature and improves the heat resistance of capacitor 2001.

Heat-conductive grease can be applied onto surfaces of end sections 203A and 223A of supporters 203 and 223 contacting busbars 202 and 222. This grease allows heat in capacitor element 101 to dissipate heat efficiently via supporters 203 and 223. The heat-conductive grease is made of general grease, such as silicone grease, fluorine-based grease, mixed with highly heat-conductive powder formed of, e.g. boron nitride, aluminum nitride, or zinc oxide.

Before insert-molding supporters 203 and 223 in package 204, busbars 202 and 222 are positioned via supporters 203 and 223, thereby positioning capacitor elements 101 coupled with busbars 202 and 222. This process accurately positions, in mold 225, capacitor elements 101 having larger dimensional variations than busbars 202 and 222, thus allowing molded capacitor 2001 with high dimensional accuracy to be manufactured.

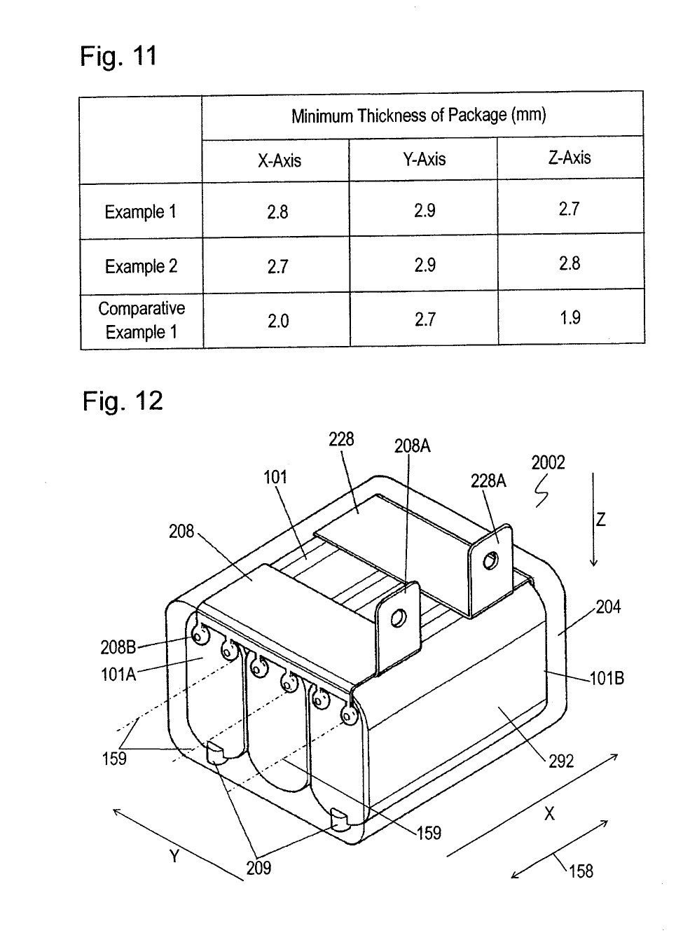

A sample of Example 1 of molded capacitor 2001 in accordance with Embodiment 3 was produced. A sample of Comparative Example 1 including no supporters 203 and 223 was produced. The dimensional accuracies of these two samples were measured. As shown in FIG. 8A, an X-axis along longitudinal direction 158 of plural capacitor elements 101 is defined. A Y-axis is defined along a direction in which capacitor elements 101 are arranged. A Z-axis is defined as a direction perpendicular to the X-axis and the Y-axis. The minimum thickness along the X-axis, the Y-axis, and the Z-axis of the samples of Example 1 and Comparative Example 1 were measured, and the results are shown in FIG. 11. The predetermined thickness, i.e. design value, was 3.0 mm.

As shown in FIG. 11, the sample of Example 1 maintains the thickness of package 204 almost equal to the predetermined value along the X-axis, the Y-axis, and the Z-axis; however the sample of Comparative Example 1 having no supporters 203 and 223 has a small thickness particularly in the Z-axis due to the own weight of capacitor elements 101.

In molded capacitor 2001 in accordance with Embodiment 3, the heat generated by capacitor elements 101 transmit to the outside of package 204 via supporters 203 and 223. This structure thus prevents capacitor elements 101 from raising its temperature and improves the heat resistance of capacitor 2001. The temperature of capacitor element 101 of molded capacitor 2001 in accordance with Embodiment 3 can be lower by about 3 to 5° C. than that of the sample of Comparative Example 1 of the capacitor element 101 including no supporters 203 or 223.

The norbornene-based monomer can be hardened within a short time, only one minute, so that molded capacitor 2001 in accordance with Embodiment 3 can be manufactured without resin case 113 used for conventional molded capacitor 501 shown in FIG. 27. Molded capacitor 2001 thus can be formed of a smaller number of components and downsized as well as light-weighted, and manufactured at a lower cost. Capacitor 2001 can improve its productivity substantially, so that it can be manufactured at a lower cost.

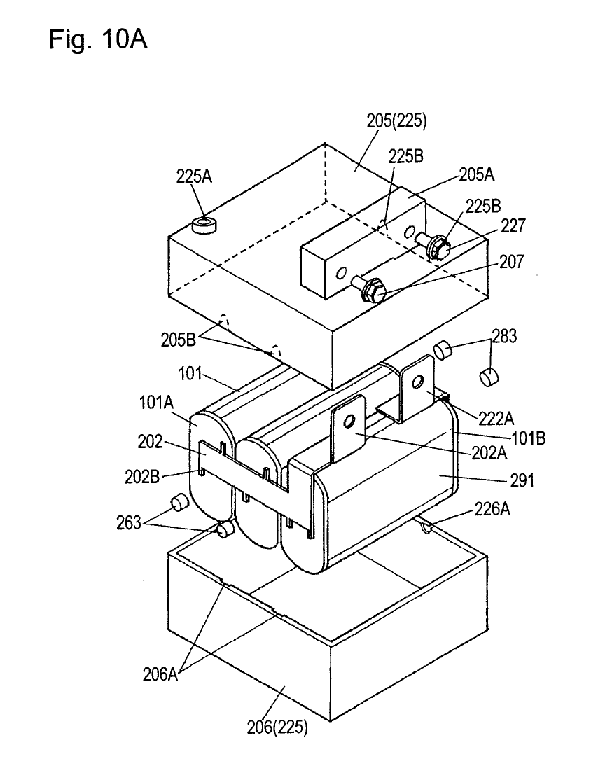

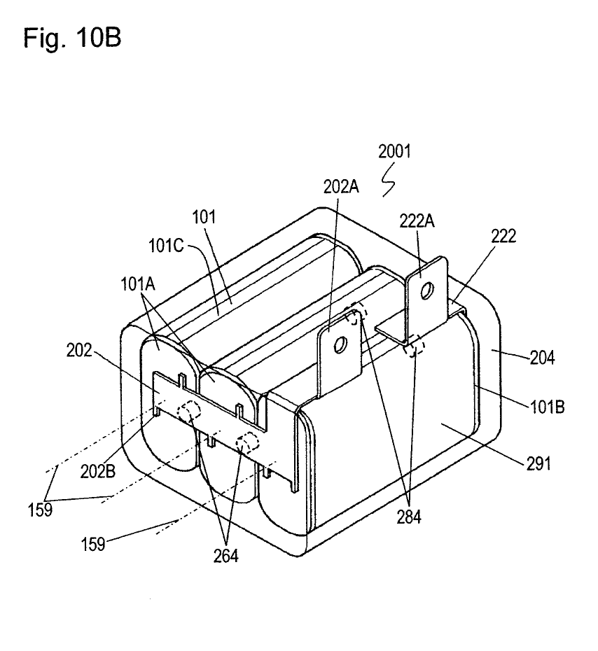

According to Embodiment 3, supporters 203 and 223 are insert-molded in package 204; however, the present invention is not limited to this method. FIGS. 10A and 10B are perspective views of the molded capacitor in accordance with Embodiment 3 for illustrating another method of manufacturing the capacitor. As shown in FIG. 10A, instead of supporters 203 and 223, pins 263 and 283 are placed in the mold together with capacitor-element assembly 291 for molding package 204. Then, the pins 263 and 283 are pulled out so that cavities for accommodating supporters 203 and 223 can be formed. Supporters 203 and 223 are then press-fitted into the cavities and embedded into package 204.

According to Embodiment 3, three capacitor elements 101 are coupled together in parallel; however, the number of capacitor elements 101 is not limited to three, or may be one.

According to Embodiment 3, molded capacitor 2001 is a rolled-type metallized-film capacitor; however, capacitor 2001 is not limited to this type, and it can be another type, e.g. multilayer metallized-film capacitor.

### Exemplary Embodiment 4

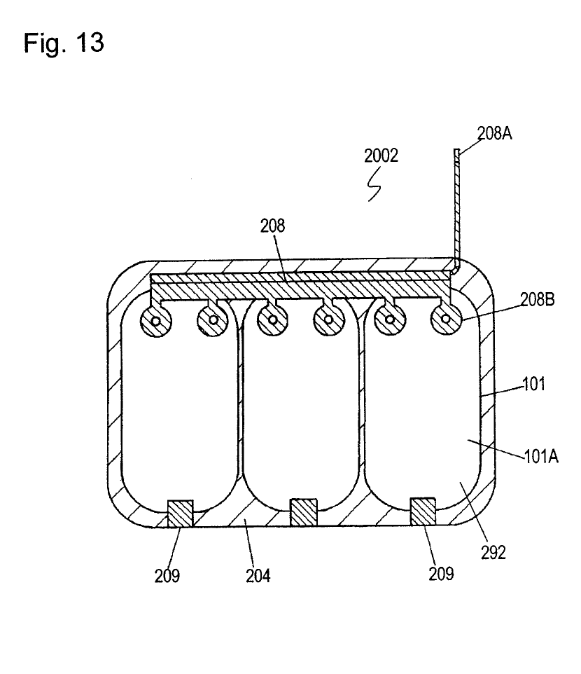

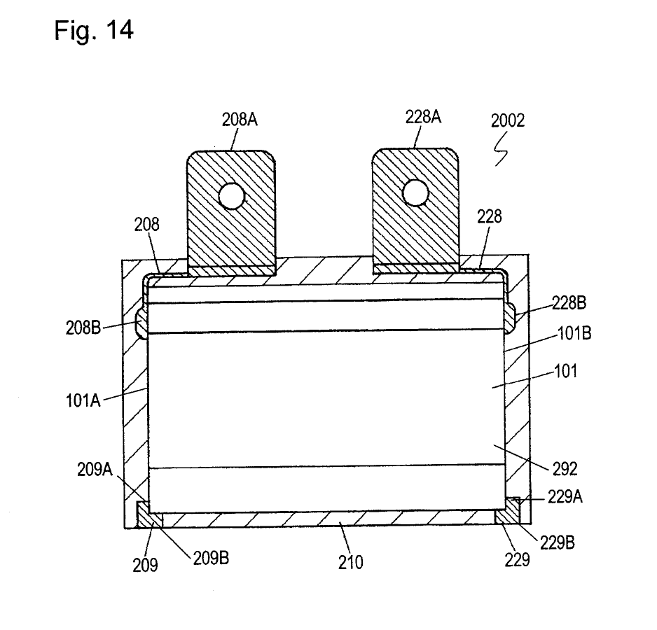

FIG. 12 is a perspective view of molded capacitor 2002 in accordance with Embodiment 4. FIGS. 13 and 14 are a front sectional view and a side sectional view of molded capacitor 2002. FIGS. 12 to 14, components identical to those of molded capacitor 2001 shown in FIGS. 8A and 9 are denoted by the same reference numerals, and their description will be omitted.

Busbar made of metal 208 includes connecting sections 208B connected to electrodes 101A of capacitor elements 101 by soldering and terminal 208A for external connection. Busbar 228 made of metal includes connecting sections 228B connected to electrodes 101B of capacitor elements 101 by soldering and terminal 228A for external connection. Busbars 208 and 228 extend across side surfaces 101C of electrodes 101A of plural capacitor elements 101 perpendicularly to center axes 159 of capacitor elements 101. Capacitor elements 101 and busbars 208 and 228 joined capacitor elements 101 together form capacitor-element assembly 292.

Package 204 is made of norbornene-based resin, and covers capacitor elements 101, busbars 208 and 228 together such that terminals 208A and 228A of busbars 208 and 228 can be exposed.

Supporter 209 embedded in package 204 includes end section 209A contacting electrode 101A and end section 209B exposed from package 204. End sections 209B does not project from package 204 but are flush with a lower surface of package 204. Supporter 229 embedded in package 204 includes end section 229A contacting electrode 101B and end section 229B exposed from package 204. End sections 229B do not projects from package 204 but are flush with the lower surface of package 204. Supporters 209 and 229 are made of insulating material having higher heat conductivity than package 204.

To be more specific, both of supporters 209 and 229, similar to supporters 103 and 123 shown in FIG. 4A, are made of insulating material selected from the group consisting of silica, alumina, magnesium oxide, silicon nitride, boron nitride, and aluminum nitride. Similar to supporters 103 and 123 shown in FIG. 4B, supporters 209 and 229 can be made of resin and semiconductor, e.g. zinc oxide or silicon carbide, mixed with the resin. Similar to supporters 103 and 123 shown in FIG. 4C, supporters 209 and 229 can be made of conductor, such as copper, aluminum, or iron, and insulator for covering the conductor. Supporters 209 and 229 are preferably made of alumina or magnesium oxide from a cost viewpoint. End sections 209A and 229A of supporters 209 and 229 are joined to capacitor-element assembly 292.

Similar to supporter 103 and 123 shown in FIG. 4D, supporters 209 and 229 can be made of insulating fiber and resin which covers and bundles the insulating fiber. The insulating fiber can be, e.g. carbon fiber, glass fiber, ultrahigh molecular weight polyethylene fiber, or liquid crystalline resin fiber. Supporters 209 and 229 formed of the insulating fiber have high heat-conductivity along an extending direction of the fiber, so that high-heat conductivity cannot be obtained between each line of the fiber. Since supporters 209 and 229 allow the heat to transmit from end section 209A and 229A which contact capacitor elements 101 to end section 209B and 229B, the insulating fiber extends from end section 209A and 229A to end section 209B and 229B of supporters 209 and 229.

A sample of Example 2 of molded capacitor 2002 in accordance with Embodiment 4 was produced, and the dimensional accuracy of the sample was measured. As shown in FIG. 12, An X-axis is defined in longitudinal direction 158 of plural capacitor elements 101, and a T-axis is defined in a direction in which capacitor elements 101 are arranged. A Z-axis is defined in a vertical direction perpendicular to the X-axis and the Y-axis. The minimum thickness along the X-axis, the Y-axis, and the Z-axis of the sample for Example 2 are measured, and the results are shown in FIG. 11. The predetermined thickness, i.e. design value, is 3.0 mm.

As shown in FIG. 11, the sample of Example 2 maintains the thickness of package 204 almost equal to the predetermined value along X-axis, Y-axis and Z-axis; however the sample of Comparative Example 1 having no supporters 209 or 229 have a smaller thickness due to the weight of capacitor elements 101, in particular, along Z-axis.

Molded capacitor 2002 in accordance with Embodiment 4 allows the heat generated by capacitor elements 101 to be dissipated to the outside of package 204 via supporters 209 and 229. This structure thus prevents capacitor elements 101 from raising its temperature and improves the heat resistance of capacitor 2002.

The norbornene-based monomer can be hardened within only one minute, so that molded capacitor 2002 in accordance with Embodiment 4 can be manufactured without using resin case 113 used for conventional molded capacitor 501 shown in FIG. 27. Molded capacitor 2002 thus can include a smaller number of components and downsized as well as light-weighted, and manufactured at a lower cost. Capacitor 2002 can improve its productivity substantially, so that it can be manufactured at a still low cost.

### Exemplary Embodiment 5

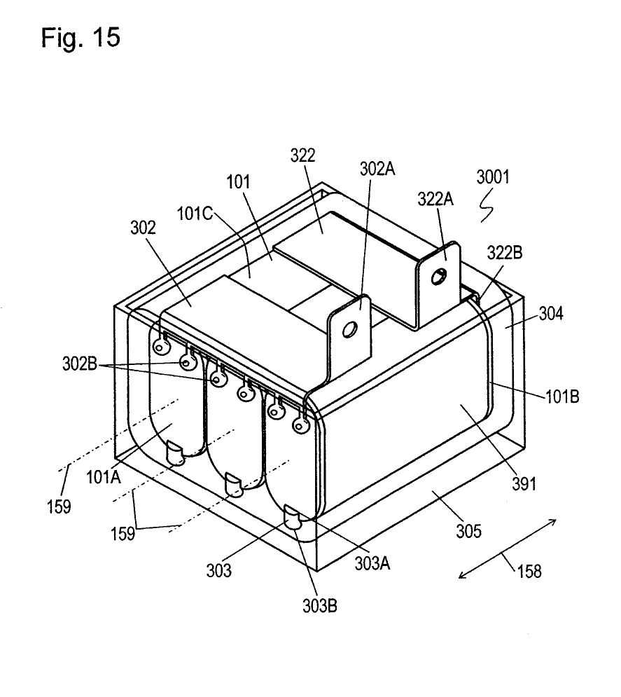

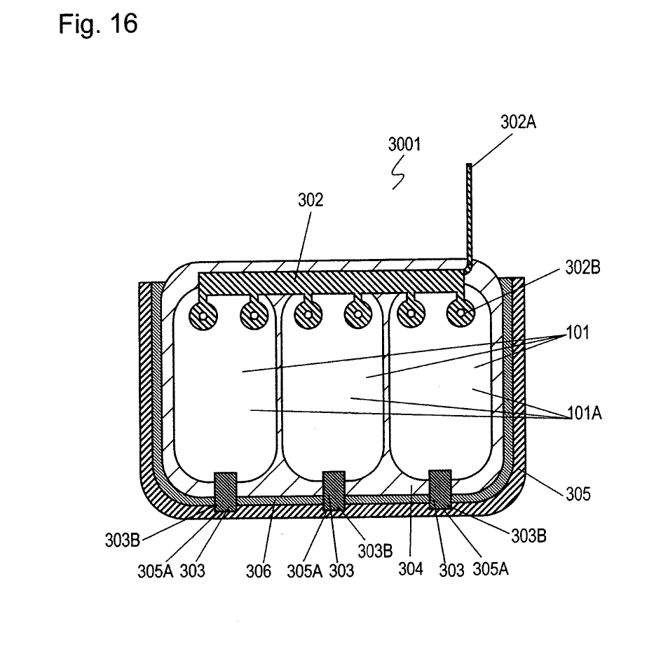

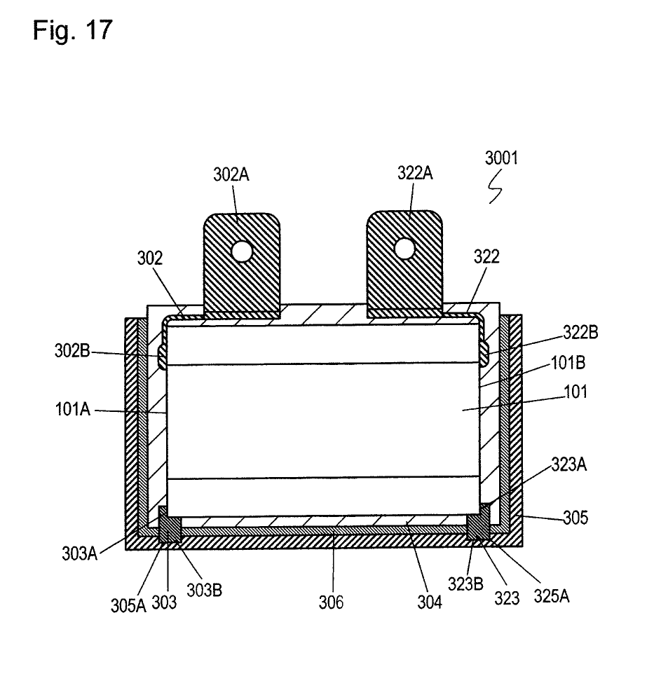

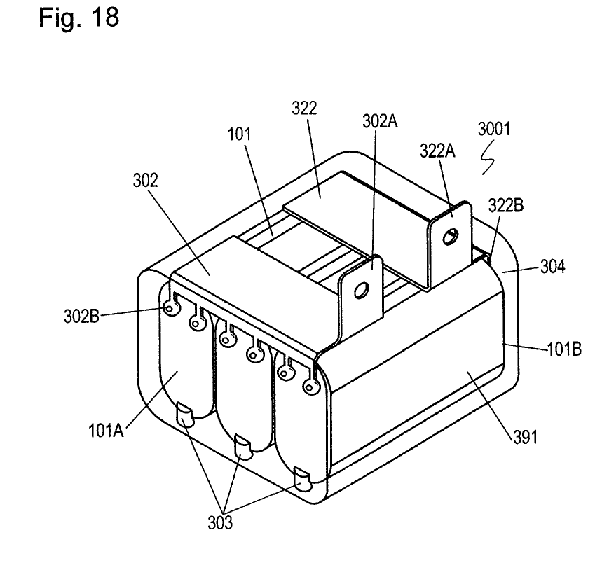

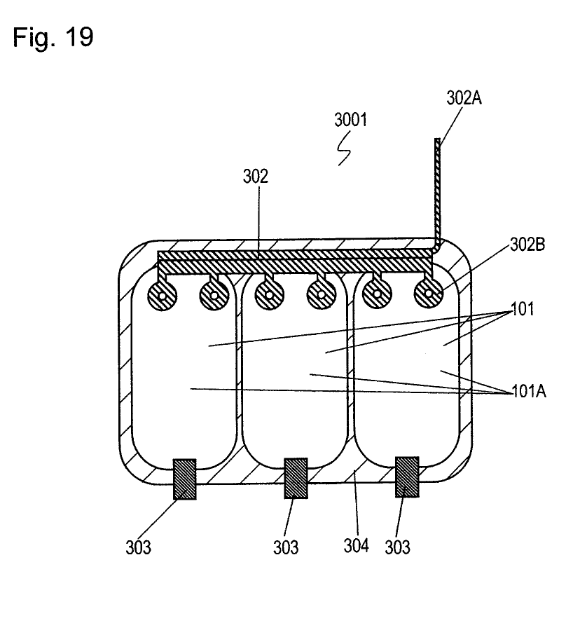

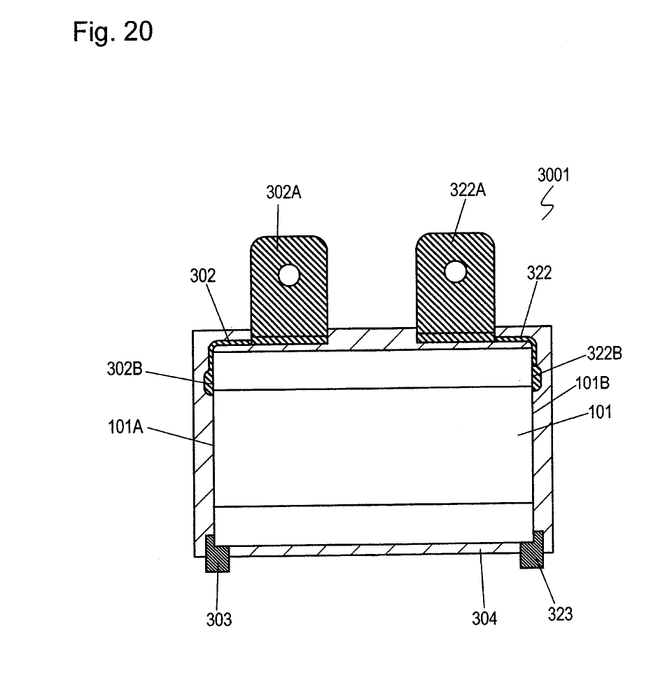

FIG. 15 is a perspective view of molded capacitor 3001 in accordance with Exemplary Embodiment 5 of the present invention. FIGS. 16 and 17 are a front sectional view and a side sectional view of molded capacitor 3001, respectively. FIG. 18 is a perspective view of package 304 accommodated in case 305 of molded capacitor 3001. FIGS. 19 and 20 are a front sectional view of and a side sectional view of package 304, respectively. In FIGS. 15 to 20, components identical to those of molded capacitor 1001 in accordance with Embodiment 1 shown in FIGS. 1A to 3 are denoted by the same reference numerals, and the descriptions thereof are omitted here.

Case 305 is made of highly heat-conductive metal, such as aluminum. Busbar 302 made of metal includes connecting sections 302B connected to electrodes 101A of capacitor elements 101 by soldering and terminal 302A for external connection. Busbar 302 made of metal includes connecting sections 322B connected to electrodes 101B of capacitor elements 101 by soldering and terminal 322A for external connection. Busbars 302 and 322 extend across side surfaces 101C of multiple capacitor elements 101 perpendicularly to center axes 159 of capacitor elements 101. Capacitor elements 101, busbars 320 and 322 for joining capacitor elements 101 together constitute capacitor-element assembly 391.

Package 304 is made of norbornene-based resin, and covers capacitor elements 101, busbars 302 and 322 together such that terminals 302A and 322A of busbars 302 and 322 are exposed.

Supporters 303 embedded in package 304 include end sections 303A contacting electrodes 101A of capacitor elements 101 and end sections 303B projected and exposed from package 304. Supporters 323 embedded in package 304 include end sections 323A contacting electrodes 101B of capacitor elements 101 and end sections 323B projecting and exposed from package 304. Both of supporters 303 and 323 are made of insulating material having higher heat conductivity than package 304. To be more specific, both of supporters 303 and 323, similar to supporters 103 and 123 shown in FIG. 4A, are made of insulating material selected from the group consisting of silica, alumina, magnesium oxide, silicon nitride, boron nitride, and aluminum nitride. Similar to supporters 103 and 123 shown in FIG. 4B, supporters 303 and 323 can be made of resin and semiconductor, e.g. zinc oxide or silicon carbide, mixed with the resin. Similar to supporters 103 and 123 shown in FIG. 4C, supporters 303 and 323 can be made of conductor, such as copper, aluminum, or iron, and insulator for covering the conductor. Supporters 303 and 323 are preferably made of alumina or magnesium oxide from a cost viewpoint. End sections 303A and 323A of supporters 303 and 323 are joined to capacitor-element assembly 391.

Similar to supporter 103 and 123 shown in FIG. 4D, supporters 303 and 323 can be made of insulating fiber and resin which covers and bundles the insulating fiber. The insulating fiber can be, e.g. carbon fiber, glass fiber, ultrahigh molecular weight polyethylene fiber, or liquid crystalline resin fiber. Supporters 303 and 323 made of the insulating fiber have high heat-conductivity along the extending direction of the fiber, so that high heat conductivity cannot be obtained between each line of the fiber. Since supporters 303 and 323 allow the heat to transmit from end sections 303A and 323A contacting capacitor elements 101 to end sections 303B and 323B, the insulating fiber extends from end sections 303A and 323A to end sections 303B and 323B of supporters 303 and 323.

Supporters 303 and 323 are placed in a mold, and capacitor elements 101 connected with busbars 302 and 322 are placed on supporters 303 and 323. Then, norbornene-based monomer is injected into the mold for forming package 304 by a reaction injection molding (RIM) method which reacts and hardens the monomer. Package 304 exposes terminals 302A and 322A from its upper surface. Supporters 303 and 323 are exposed and project from its lower surface.

The norbornene-based monomer, the material for package 304, is two-part hardening type dicyclopentadiene (DCPD); however, it can be one-part hardening type DCPD that uses ruthenium catalyst.

Case 305 is made of metal, such as aluminum, having high heat conductivity, and accommodates capacitor elements 101 covered with package 304. Recesses 305A and 325A are provided in an inner surface of the case 305. Supporters 303 and 323 are harder than the norbornene-based monomer, i.e. the material for package 304. End sections 303B and 323B projecting from the lower surface of package 304 are fitted into recesses 305A and 325A, thereby positioning package 304 respect to case 305.

Insulating molding resin 306 fills between case 305 and package 304. Resin 306 is made of insulating resin, such as urethane resin or epoxy resin. The insulating resin can be mixed with heat-conductive filler or foaming agent.

Molding resin 306 made of insulating resin, such as urethane resin or epoxy resin, mixed with heat-conductive filler for filling case 305 which accommodates package 304 allows capacitor elements 101 to produce much more heat-dissipation effect. The insulating resin mixed with the foaming agent as the materials of molding resin 306 increases the resistance against vibration.

End sections 303A and 323A of supporters 303 and 323 made of insulating material having high heat conductivity contact electrodes 101A and 101B of capacitor elements 101, respectively, while end sections 303B and 323B are exposed from package 304. This structure allows the heat generated by capacitor elements 101 to be dissipated to the outside of package 304 via supporters 303 and 323. The foregoing structure thus prevents capacitor elements 101 from raising the temperature and improves the heat resistance of capacitor 3001. Supporters 303 and 323 exposed from package 304 contact the inner surface of case 305, facilitating the heat dissipation from capacitor elements 101. This structure thus prevents capacitor elements 101 from raising the temperature and improves resistance to heat of capacitor 3001.

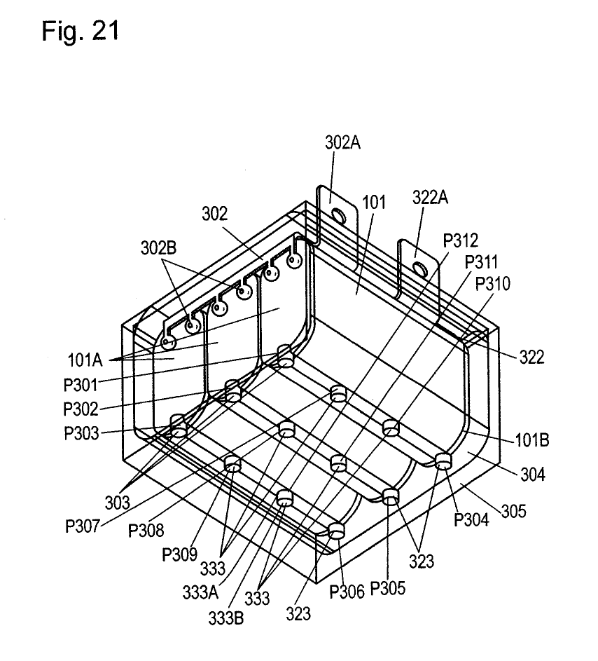

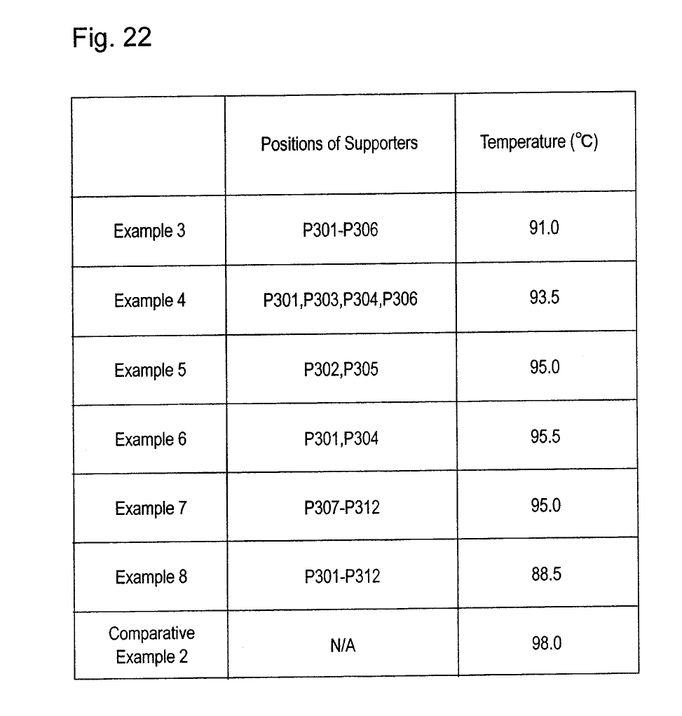

FIG. 21 is a bottom perspective view of molded capacitor 3001 in accordance with Embodiment 1. As shown in FIG. 21, supporters 303 are placed at positions P301, P302, and P303 to contact electrodes 101A of capacitor elements 101, while supporters 323 are placed at positions P304, P305, and P306 to contact electrodes 101B of capacitor elements 101. End portions 333A of supporters 333 contact positions P307 to P312 on side surfaces 101C of elements 101. Supporters 333 include end sections 333B opposite to end sections 333A. End sections 333B are exposed from package 304. As discussed above, supporters 303, 323 and 333 are placed at various positions P301 to 312 in molded capacitor 3001. Samples of this capacitor 3001 of Examples 3 to 8 are produced, and supporters 303, 323 and 333 of these samples are made of alumina. FIG. 22 illustrates the positions where those supporters are placed. No supporter out of the supporters at positions P301 to P312 is placed at any position which is not shown in FIG. 22. To be more specific, in the sample of Example 3, supporters 303 and 323 are placed at positions P301 to 306, but no supporter 333 are placed at positions P307 to 312. In samples of Example 4, supporters 303 and 323 are placed at positions P301, P303, P304, and P306, but no supporter are placed at positions P302, P305, or P307 to 312. In a sample of Example 5, supporters 303 and 323 are placed at positions P302 and P305, but no supporters are placed at positions P301, P303, P304, P306, or P307 to P312. In the sample of Example 6, supporters 303 and 323 are placed at positions P301 and P304, but no supporters are placed at positions P302, P303, P305, P306, or P307 to 312. In sample of Example 7, supporters 333 are placed at positions P307 to 312, but no supporters are placed at positions P301 to 306. In samples of Example 8, supporters 303, 323, and 333 are placed at all of position P301 to P312.

A sample for comparative example 2 was also produced, and this sample is similar to the samples of Examples 3 to 8, but it includes none of supporters 303, 323, and 333. Samples for Examples 3 to 8 and comparative example 2 have the temperatures measured at supporters 303, 323 and 333 under the condition of atmospheric temperature of 85° C. and the temperature of the lower surface of the case 305 of 65° C. FIG. 22 shows the measurement result. In the sample of comparative example 2, a temperature of package 304 is measured.

As shown in FIG. 22, in the sample of Example 8 with supporters 303, 323 and 333 placed at all positions P301 to P312 exhibited the lowest temperature of 88.5° C. while the sample of comparative example 2 having no supporters had a temperature of 98° C., so that the sample of Example 8 produces heat dissipation effect greater than the sample for comparative example 2 by about 10° C. In the sample of Example 3, supporters 303 and 323 are placed at positions P301 to P306 where electrodes 101A and 101B produces rather great heat dissipation effect. The sample of Example 4 with the supporters placed at positions P301, P303, P304, and P306 also produces rather great heat dissipation effect. However, the samples of Examples 5, 6, and 7 produce smaller heat dissipation effect because the end sections of the supporters do not contact electrode 101A or 101B, or the supporters contact electrodes 101A and 101B but the number of the supporters is smaller. The end sections of the supporters preferably contact electrodes 101A and 101B.

Heat-conductive grease can be applied onto surfaces of end sections 303A and 323A of supporters 303 and 323 contacting electrodes 101A and 101B of capacitor element 101. The heat-conductive grease can be also applied onto surfaces of end sections 303B and 323B of supporters 303 and 323 contacting case 305. This grease allows capacitor element 101 to dissipate heat efficiently via supporters 303 and 323. The heat-conductive grease is made of general grease, such as silicone grease, fluorine-based grease, mixed with highly heat-conductive powder formed of, e.g. boron nitride, aluminum nitride, or zinc oxide.

Supporters 303 and 323 can position the capacitor elements 101 coupled with busbars 302 and 322 in the mold, so that package 304 can be molded with accurate dimensions.

The norbornene-based monomer can be hardened within a short period of time, such as only one minute, so that molded capacitor 3001 in accordance with Embodiment 5 can be manufactured without resin case 113 used for conventional molded capacitor 501 shown in FIG. 27. Molded capacitor 3001 thus can include a smaller number of components and downsized as well as light-weighted, and manufactured at the lower cost. Capacitor 3001 can improve its productivity substantially, so that it can be manufactured at a still further low cost.

According to Embodiment 5, supporters 303 and 323 contact electrodes 101A and 101B of capacitor element 101. The molded capacitor in accordance with Embodiment 5 includes three capacitor elements 101 coupled together with busbar 302, so that it is not necessarily for supporters 303 and 323 to contact all the three elements 101. In this case, the number of supporters 303 and 323 can be smaller than the number of capacitor elements 101, and yet, capacitor elements 101 can still produce the advantages discussed above, i.e. capacitor elements 101 can dissipate heat sufficiently and can be positioned accurately.

End sections 303A and 323A of supporter 303 and 323 contact electrodes 101A and 101B of capacitor element 101, and end section 303B and 323B are exposed from package 304. According to Embodiment 5, end sections 303A and 323A of supporters 303 and 323 can be connected to busbars 302 and 322. Busbars 302 and 303 are made of highly heat-conductive metal, and allow the heat generated by capacitor elements 101 to transmit to supporters 303 and 323 via busbars 302 and 322. Capacitor elements 101 thus can dissipate the heat efficiently. As discussed above, capacitor elements 101 coupled with busbars 302 and 322 are placed in the mold which forms package 304, so that supporters 303 and 323 can position capacitor elements 101 although supporters 303 and 323 contact busbars 302 and 322.

According to Embodiment 5, supporters 303 and 323 are insert-molded to package 304; however, it is not limited to this method. Instead of supporters 303 and 323, pins can be placed in the mold together with capacitor-element assembly 391 for molding package 304. Then, the pins are pulled out so that cavities for accommodating supporters 303 and 323 can be formed. Then, supporters 303 and 323 are press-fitted into the cavities to be embedded into package 304.

According Embodiment 5, molded capacitor 3001 has recesses 305A and 325A provided in the inner surface of case 305, and end sections 303B and 323B of supporters 303 and 323 are fitted into recesses 305A and 325A; however, case 305 may not necessarily have recesses 305A and 325A therein. For instance, as long as supporters 303 and 323 contact the inner surface of case 305, an advantage of heat dissipation similar to what is discussed previously can be obtained.

According to Embodiment 5, three capacitor elements 101 are coupled together in parallel; however, the number of capacitor element 101 is not limited to three, or multiple capacitor elements 101 are not always needed.

According to Embodiment 5, molded capacitor 3001 includes roll-type metallized-film capacitors; however, capacitor 3001 is not limited to this type, and it can be another type, such as multilayer metallized film capacitors.

### Exemplary Embodiment 6

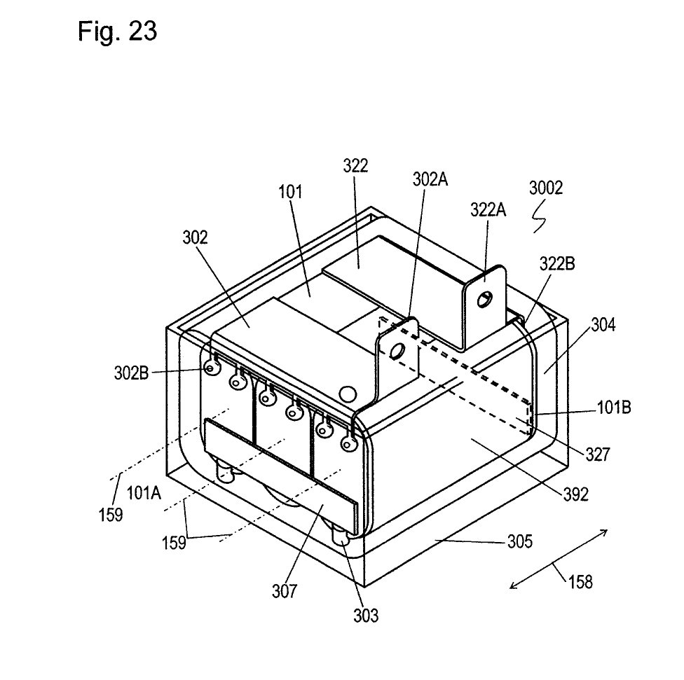

FIG. 23 is a perspective view of molded capacitor 3002 in accordance with Exemplary Embodiment 6 of the present invention. In FIG. 23, components identical to those of molded capacitor 3001 in accordance with Embodiment 5 shown in FIGS. 15 to 20 are denoted by the same reference numerals, and their description will be omitted. Molded capacitor 3002 includes metal plate 307 joined to electrodes 101A of plural capacitor elements 101 and metal plate 327 joined to electrodes 101B of capacitor elements 101 in addition to molded capacitor 3001 in accordance with Embodiment 5. Metal plates 307 and 327 extend perpendicularly to center axes 159 of capacitor elements 101, and couples three capacitor elements 101 together in parallel similarly to busbars 302 and 322.

Metal plate 307 can contact supporter 303 or can be isolated from supporter 303. Metal plate 327 can contact supporter 323 or it can be isolated from supporter 323. Capacitor 3002 may not include one of metal plates 307 and 327.

Metal plates 307 and 327 of molded capacitor 3002 in accordance with Embodiment 6 allow each of capacitor elements 101 to have a uniform temperature, so that elements 101 can further suppress the rise in temperature and dissipate the heat efficiently.

### Exemplary Embodiment 7

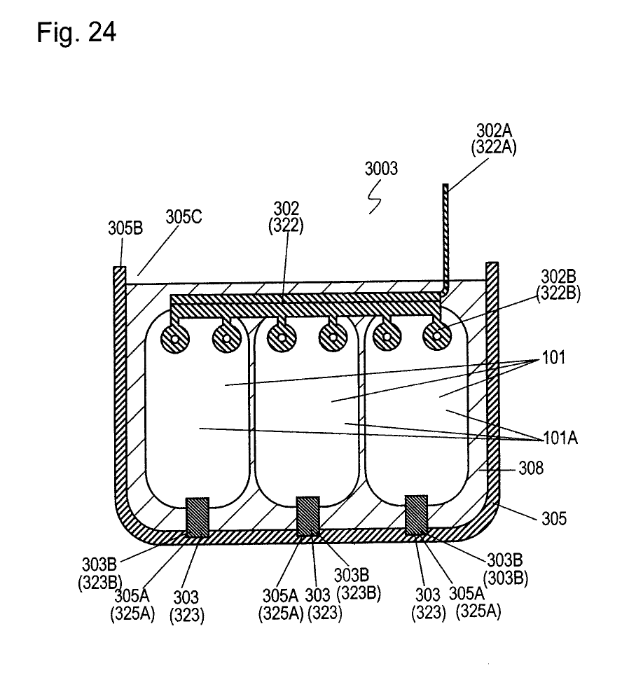

FIG. 24 is a front sectional view of molded capacitor 3003 in accordance with Exemplary Embodiment 7. In FIG. 24, components identical to those of molded capacitor 3001 in accordance with Embodiment 5 shown in FIGS. 15 to 17 are denoted by the same reference numerals, and their description will be omitted. Molded capacitor 3003 in accordance with Embodiment 7 includes package 308 covering capacitor elements 101 and busbars 302 and 322 instead of package 304 and molding resin 306 of molded capacitor 3001 in accordance with Embodiment 5. Package 308 contacts capacitor elements 101 and busbars 302 and 322 and further contacts the inner surface of case 305. Package 308 is made of norbornene-based resin similarly to package 304. To be more specific, package 308 fills case 305, and functions as a package, similarly to capacitor 3001 in accordance with Embodiment 5, for covering capacitor elements 101 and busbars 302 and 322. Case 305 has upper end 305B and upper opening 305C surrounded by upper end 305B.

The norbornene-based monomer, the material of package 308, is two-part hardening type dicyclopentadiene (DCPD); however, it can be one-part hardening type DCPD that uses ruthenium catalyst.

As shown in FIG. 24, in molded capacitor 3003, upper end 305B of case 305 is located above the upper end of busbar 302 placed on the upper surface of capacitor elements 101. This structure allows package 308 made of norbornene-based resin to cover busbars 302 and 322 with terminals 302A and 322A exposed.

End sections 303A and 323A of supporters 303 and 323 contact the lower part of capacitor elements 101, and end sections 303B and 323B appearing from package 308 contact the inner surface of case 305.

Supporters 303 and 323 are made of highly heat-conductive insulating material, and end sections 303A and 323A of the supporters contact electrodes 101A and 101B of capacitor element 101, and end sections 303B and 323B are exposed from package 308. This structure allows the heat generated by elements 101 to dissipate to the outside of package 308 via supporters 303 and 323, so that capacitor elements 101 can suppress temperature rise, and the heat resistance of capacitor 3003 can be improved. Since portions of supporters 303 and 323 exposed from package 308 contact the inner surface of case 305, capacitor elements 101 expedites heat dissipation, and suppresses the temperature rise, so that the heat resistance of capacitor 3003 can be improved.

Norbornene-based resin has, in general, higher resistance to humidity and greater rigidity than thermosetting resin, such as epoxy resin, so that molded capacitor 3003 in accordance with Embodiment 7 has excellent humidity proof, strength, impact proof, and reliability.

Next, a method of manufacturing molded capacitor 3003 in accordance with Embodiment 7 will be demonstrated below. First, busbars 302 and 322 are joined to capacitor elements 101, and then, capacitor elements 101 coupled with busbar 302 are placed in case 305. At this moment, as shown in FIG. 24, end sections 303B and 323B of supporters 303 and 32 are press-fit into recesses 305A and 325A of case 305, thereby positioning capacitor elements 101 and busbars 302 and 322 with respect to case 305.

After the positioning, the norbornene-based monomer is injected through opening 305 of case 305 such that the monomer reaches a level not higher than upper end 305B of case 305, and embeds elements 101 and busbars 302, 322 therein. Case 305 is thus filled with the norbornene-based monomer. Then, the monomer is hardened, thereby providing molded capacitor 3003.

In the method according to Embodiment 7, the norbornene-based monomer is injected into case 305 directly and is hardened for molding package 308. End sections 303B and 323B are exposed from package and contact the inner surface of case 305.

In the manufacturing method according to Embodiment 7, capacitor elements 101 and busbars 302 and 323 placed in case 305 are covered with package 308 made of norbornene-based resin, thereby simply completing molded capacitor 3003. This method thus needs no molding resin 306, which is used in capacitor 3001 in accordance with Embodiment 5, made of urethane resin or epoxy resin. The manufacturing method in accordance with Embodiment 7 thus can shorten the time needed for manufacturing, and on top of that, since the norbornene-based resin can be hardened in a shorter time, the productivity can be further improved.

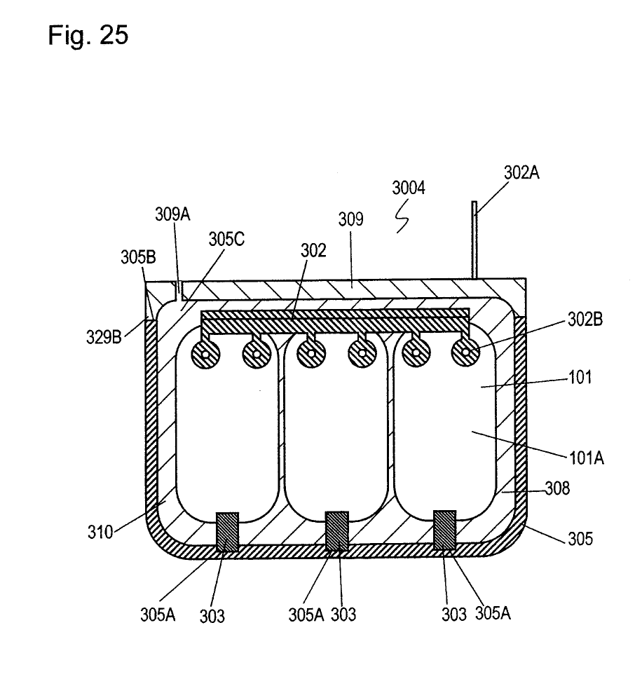

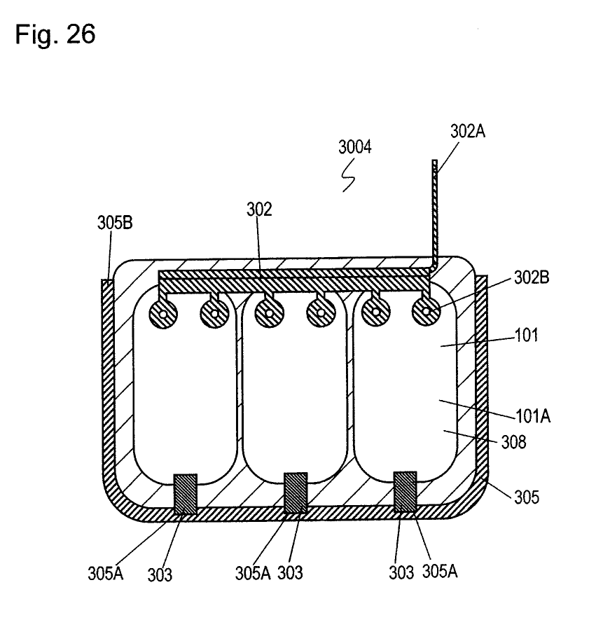

FIGS. 25 and 26 are front sectional views of another molded capacitor 3004 in accordance with Embodiment 7 for illustrating a method of manufacturing molded capacitor 3004. FIG. 26 in particular is a front sectional view of molded capacitor 3004. In these figures, components identical to those of molded capacitor 3003 shown in FIG. 24 are denoted by the same reference numerals, and their description will be omitted.

As shown in FIG. 25, inlet hole 309A is provided in upper mold 309 for injecting the norbornene-based monomer into case 305. First, capacitor elements 101 coupled with busbar 302 are positioned in case 305 with supporters 303 and 323. Then, upper mold 309 is solidly and rigidly mounted onto the upper surface of case 305. Lower end 329B of upper mold 309 has the same shape as the rectangular shape of upper end 305B of case 305.

Upper mold 309 has holes therein through which terminals 302A and 322A of busbars 302 and 322 extend. When upper mold 309 is solidly and rigidly mounted to case 305, terminals 302A and 322A extend through these holes, which are designed such that there are spaces as small as possible between the inner wall of the holes and outer wall of terminal 302A. This design prevents the norbornene-based monomer from leaking from the holes when the monomer is injected into case 305.

Upper mold 309 solidly and rigidly mounted onto upper end 305B of case 305 forms cavity 310 between the lower surface of upper mold 309 and the inner wall of case 305.

Then, the norbornene-based monomer is injected from inlet 309A into cavity 310 so that cavity 310 can be filled with the monomer.

The norbornene-based monomer is hardened for molding package 304, and then, upper mold 309 is removed, thereby providing capacitor 3004 shown in FIG. 26.

Molded capacitor 3004 differs from capacitor 3003 shown in FIG. 24 in the position of the upper end of package 304, i.e. the upper end of package 304 of capacitor 3004 is located over upper end 305B of case 305. However, capacitor 3004 is as excellent as capacitor 3003 in performance and reliability.

When the norbornene-based monomer is injected into cavity 310, the upper opening of case 305 is sealed with upper mold 309, so that the monomer can be prevented from leaking outside case 305. As a result, the productivity of molded capacitor 3004 can be improved.

### INDUSTRIAL APPLICABILITY

A molded capacitor according to the present invention has high heat proof, and a small size as well as light weight, and can be manufactured at a low cost, so that the molded capacitor is useful for the automobile industry.

### DESCRIPTION OF REFERENCE SIGNS

101A Electrode (First Electrode, Second Electrode)

101 Capacitor Element (First Capacitor Element, Second Capacitor Element)

102 Busbar

102A Terminal

104 Package

103 Supporter

103A End Section (First End Section)

103B End Section (Second End Section)

105 Case

105A Recess

106 Molding Resin

151 Dielectric Film

152 Electrode Film (First Electrode Film)

155 Electrode Film (Second Electrode Film)

191 Capacitor-Element Assembly

202 Busbar

202A Terminal

203 Supporter

203A End Section (First End Section)

203B End Section (Second End Section)

204 Package

208 Busbar

208A Terminal

209 Supporter

209A End Section (First End Section)

209B End Section (Second End Section)

225 Mold

263 Pin

264 Cavity

291 Capacitor-Element Assembly

302 Busbar

302A Terminal

303 Supporter

303A End Section (First End Section)

303B End Section (Second End Section)

304 Package

305 Case

307 Metal Plate

309 Upper Mold

310 Cavity

391 Capacitor-Element Assembly

448 Heat-Conductive Grease

449 Heat-Conductive Grease

1. A molded capacitor comprising:
a capacitor-element assembly including
a first capacitor element having a first electrode, and
a busbar having a terminal and joined to the first electrode of the first capacitor element;
a package made of norbornene-based resin for covering the capacitor-element assembly with the terminal of the busbar exposed from the package; and
a supporter embedded in the package, the supporter having a first end section and a second end section, the first end section of the supporter contacting the capacitor-element assembly, the second end section of the supporter being exposed from the package, the supporter being made of heat-conductive insulating material.

2. The molded capacitor according to claim 1, wherein the first end section of the supporter contacts the first capacitor element.

3. The molded capacitor according to claim 1, wherein the first end section of the supporter contacts the busbar.

4. The molded capacitor according to claim 1, wherein
the supporter is made of an insulating material selected from the group consisting of silica, alumina, magnesium oxide, silicon nitride, boron nitride, and aluminum nitride, or
the supporter is made of resin mixed with zinc oxide or silicon carbide, or
the supporter includes a conductor and an insulator for covering the conductor, the conductor being made of material selected from the group consisting of copper, aluminum and iron.

5. The molded capacitor according to claim 1, wherein the supporter contains
insulating fiber arranged along a predetermined direction, the insulating fiber being selected from the group consisting of carbon fiber, glass fiber, ultrahigh molecular weight polyethylene fiber, and liquid crystalline resin fiber, and
a resin for covering the insulating fiber.

6. The molded capacitor according to claim 1, further comprising a heat-conductive grease applied to a surface of the supporter contacting the capacitor-element assembly.

7. The molded capacitor according to claim 1, wherein the first capacitor element further includes
a dielectric film having a first surface and a second surface opposite to the first surface of the dielectric film,
a first electrode film formed on the first surface of the dielectric film and connected to the first electrode,
a second electrode, and
a second electrode film formed on the second surface of the dielectric film and connected to the second electrode.

8. The molded capacitor according to claim 1, wherein the capacitor-element assembly further includes a second capacitor element joined to the busbar and connected to the first capacitor element.

9. The molded capacitor according to claim 8, wherein
the second capacitor element includes a second electrode,
the capacitor-element assembly further includes a metal plate joined to the first electrode of the first capacitor element and the second electrode of the second capacitor element for coupling the first capacitor element with the second capacitor element.

10. The molded capacitor according to claim 1, further comprising a case for accommodating the capacitor-element assembly, the package, and the supporter, wherein the second end section of the supporter contacts an inner surface of the case.

11. The molded capacitor according to claim 10, wherein a recess is provided in the inner surface of the case, the second end section of the supporter fitting into the recess.

12. The molded capacitor according to claim 10, further comprising an insulating molding resin filling between the case and the package.

13. The molded capacitor according to claim 12, wherein
the molding resin is made of insulating resin selected from the group consisting of urethane resin and epoxy resin, or
the molding resin is made of mixture of the insulating resin and heat-conductive filler, or
the molding resin is made of mixture of the insulating resin and foaming agent.

14. The molded capacitor according to claim 10, wherein the case is made of metal.

15. The molded capacitor according to claim 10, further comprising a heat-conductive grease applied to a surface of the supporter contacting the case.

16. A method for manufacturing a molded capacitor, said method comprising:
forming a capacitor-element assembly which includes a first capacitor element and a busbar having a terminal, the first capacitor element including a first electrode, the busbar being joined to the first electrode of the first capacitor element; and
forming a package made of norbornene-based resin for covering the capacitor-element assembly by embedding a supporter made of a heat-conductive insulating material in the package, such that the supporter has a first end section and a second end section exposed from the package, the first end section contacting the capacitor-element assembly, and such that the terminal of the busbar is exposed from the package.

17. The method according to claim 16, wherein said forming the package comprises:
injecting norbornene-based monomer into a mold while the supporter contacts the capacitor-element assembly and is placed in the mold; and
molding the package by reacting and hardening the injected norbornene-based monomer by a reaction injection molding method.

18. The method according to claim 17, further comprising:
placing the molded package in a case while the second end section of the supporter contacts an inner surface of the case; and
after said placing the molded package in the case, filling the case with insulating molding resin.

19. The method according to claim 18, wherein
a recess is provided in the inner surface of the case, and
said placing the molded package in the case comprises positioning the molded package with respect to the case by fitting the second end section of the supporter into the recess.

20. The method according to claim 16, further comprising
placing a pin and the capacitor-element assembly in a mold, wherein
said forming the package comprises:
injecting norbornene-based monomer into the mold while the pin and the capacitor-element assembly are placed in the mold;
molding the package by reacting and hardening the injected norbornene-based monomer by a reaction injection molding method;
pulling out the pin from the molded package so as to form a cavity; and
inserting the supporter into the cavity.

21. The method according to claim 20, further comprising:
placing the molded package in a case while the second end section of the supporter contacts an inner surface of the case; and
after said placing the molded package in the case, filling the case with insulating molding resin.

22. The method according to claim 21, wherein
a recess is provided in the inner surface of the case, and
said placing the molded package in the case comprises positioning the molded package with respect to the case by fitting the second end section of the supporter into the recess.

23. The method according to claim 16, wherein said forming the package comprises:
injecting norbornene-based monomer into a case while the supporter contacts the capacitor-element assembly and is placed in the case; and
molding the package by hardening the injected norbornene-based monomer.

24. The method according to claim 23, wherein
the case has an upper end and an upper opening surrounded by the upper end,
said forming the package further comprises fixing an upper mold onto the upper end of the case to form a cavity surrounded by the case and the upper mold, and
said injecting the norbornene-based monomer into the case comprises filling the cavity with the norbornene-based monomer, said method further comprising
removing the upper mold from the case after said molding the package.
